(19) United States
(12) Patent Application Publication
(10) Pub. No.: US 2008/0053377 A1
(43) Pub. Date: Mar. 6, 2008

(54) Methods of Caring for and Breeding Ground Squirrels in Captivity

(76) Inventor: Dana K. Vaughan, Omro, WI (US)

Correspondence Address: QUARLES & BRADY LLP, 411 E. WISCONSIN AVENUE, SUITE 2040, MILWAUKEE, WI, 53202-4497, US

(21) Appl. No.: 11/847,907

(22) Filed: Aug. 30, 2007

Related U.S. Application Data
(60) Provisional application No. 60/841,473, filed on Aug. 31, 2006.

(51) Int. Cl. A01K 1/03

(52) U.S. Cl. 119/417

(57) ABSTRACT

Methods of maintaining and mating ground squirrels in captivity are disclosed. The method involves providing at least one of a high protein diet and an artificial burrow to a ground squirrel that is being kept in captivity.

### CROSS-REFERENCE TO RELATED APPLICATIONS

This application claims the benefit of U.S. provisional application Ser. No. 60/841,473, filed on Aug. 31, 2006, which is herein incorporated by reference in its entirety.

### STATEMENT REGARDING FEDERALLY SPONSORED RESEARCH OR DEVELOPMENT

Not applicable.

### BACKGROUND OF THE INVENTION

Formerly known as Sciurus tridecemlineatus and Citellus tridecemlineatus, the 13-lined ground squirrel, Spermophilus tridecemlineatus (Mitchell 1821), is a long-standing model species for studies of hibernation biochemistry and physiology (Carey, H. V. & Martin, S. L. Preservation of intestinal gene expression during hibernation. Am. J. Physiol. 271, G804-G813 (1996); Hittel, D. S. & Storey, K. B. Differential expression of mitochondria-encoded genes in a hibernating mammal. J. Exp. Biol. 205, 1625-1631 (2002); Epperson, L. E. & Martin, S. L. Quantitative assessment of ground squirrel mRNA levels in multiple stages of hibernation. Physiol. Genomics 10, 93-102 (2002); Andrews, M. T. Genes controlling the metabolic switch in hibernating mammals. Biochem. Soc. Trans. 32, 1021-1024 (2004)). It is an emerging model for studies of potential biomedical applications of hibernation physiology (Carey, H. V., Andrews, M. T. & Martin, S. L. Mammalian hibernation: cellular and molecular responses to depressed metabolism and low temperature. Physiol. Rev. 83, 1153-1181 (2003)), in diverse fields that include organ transplantation, cardiology, and neurology (Arendt, T. et al. Reversible paired helical filament-like phosphorylation of tau is an adaptive process associated with neuron al plasticity in hibernating animals. J. Neurosci. 23, 6972-6981 (2003); Cai, D., McCarron, R. M. & Hallenbeck, J. Cloning and characterization of a forkhead transcription factor gene, FoxO1a, from thirteen-lined ground squirrel. Gene 343, 203-209 (2004); Lindell, S. L. et al. Natural resistance to liver cold ischemia-reperfusion injury associated with the hibernation phenotype. Am. J. Physiol. Gastrointest. Liver Physiol. 288, G473-G480 (2005)). In June 2005, the National Human Genome Research Institute announced plans to sequence its genome as part of a mega-analysis of mammalian genome evolution, increasing the 13-liner's utility for all manner of research inquiry.

Thirteen-liners are obligate hibernators (Wade, O. The behavior of certain spermophiles with special reference to aestivation and hibernation. J. Mamm. 11, 160-188 (1930); McCarley, H. Annual cycle, population dynamics and adaptive behavior of Citellus tridecemlineatus. J. Mamm. 47, 294-316 (1966)). In Wisconsin, for example, they typically enter hibernation in October and emerge from it in April (Rongstad, O. J. A life history study of thirteen-lined ground squirrels in southern Wisconsin. J. Mamm. 46, 76-87 (1965); Craven, S. R. Ground squirrels: their ecology and control [Online]. University of Wisconsin Cooperative Extension publication G3238. http://cecommerce.uwex.edu/pdfs/G3238.PDF [7 Jul. 2005]). Spring temperature is believed to be the main zeitgeber for setting the timing of emergence (Joy, J. E. & Mrosovsky, N. Synchronization of circannual cycles: a cold spring delays the cycles of thirteen-lined ground squirrels. J. Comp. Physiol. A 156, 125-134 (1985)). Males are believed to emerge first and experience a burst of testosterone, apparently to enable sufficient regeneration of their regressed gonads to permit breeding. Seasonal maturation of the testes is marked by their enlargement and black pigmentation. Long ago, it was suggested that 13-liners are reflex ovulators (Dripps, D. Studies on the ovary of the spermophile (Spermophilus citellus tridecemlineatus) with special reference to the corpus luteum. Amer. J. Anat. 25, 117-184 (1919)), but evidence is lacking (Landau, I. T. & Holmes, W. G. Mating of captive thirteen-lined ground squirrels and the annual timing of estrus. Horm. Behav. 22, 474-487 (1988)).

Ground squirrels spend the late spring and summer months eating a varied diet of plant material, including the seeds for which they are named (spermo-, seed; philus-, lover). They also eat a surprising variety of animal tissue, including insects, birds, bird eggs, reptiles, and small mammals. Indeed, one study identified the 13-liner as second only to raccoons as the major predator of nestling grassland birds (Anderson, T. & Ribic, C. Predator activity and grassland bird nesting success in an agricultural landscape in southern Wisconsin [Online]. USGS Wisconsin Cooperative Wildlife Research Unit, University of Wisconsin Madison. http://dnr.wi.gov/org/land/er/cwcp/ribic-2004fieldreport-predators_{—}091504.pdf [6 Feb. 2006]). Metabolic changes induce a spurt of rapid weight gain in the fall, such that fat stores are built up prior to their descent into underground chambers branching off the main burrow and used solely for the several months of hibernation (Craven, S. R. Ground squirrels: their ecology and control [Online]. University of Wisconsin Cooperative Extension publication G3238. http://cecommerce.uwex.edu/pdfs/G3238.PDF [7 Jul. 2005]; Desha, P. G. Observations of the burrow utilization of the thirteen-lined ground squirrel. Southw. Nat. 11, 408-410 (1966)).

During hibernation, the animal assumes the fetal position in a nest of shredded plant material and its body temperature falls to ambient levels, often near freezing. Heart rate declines from 300 bpm to 5-10 bpm, with a concomitant decrease in ventilation rate and activity. During periodic interbout arousals, when shivering thermogenesis returns body temperature to normal, 13-liners do not eat even when food is provided (Wade, O. The behavior of certain spermophiles with special reference to aestivation and hibernation. J. Mamm. 11, 160-188 (1930)); indeed, there is a marked degeneration of the digestive tract reflecting its long disuse (Carey, H. V., Andrews, M. T. & Martin, S. L. Mammalian hibernation: cellular and molecular responses to depressed metabolism and low temperature. Physiol. Rev. 83, 1153-1181 (2003)). In this way, energetic costs are minimized to cope with months of starvation.

During interbout arousals, ground squirrels enter non-REM sleep (Larkin, J. E. & Heller, H. C. Sleep after arousal from hibernation is not homeostatically regulated. Am. J. Physiol. 276, R522-R529 (1999)) for about 24 hr and then cycle back into torpor. The interval between interbout arousals lengthens to about two weeks as the winter progresses.

In the United States at this time, all 13-liners destined for research purposes must be captured from the wild during the spring and summer months, typically from open grassy areas such as golf courses, pastures, lawns, and cemeteries (e.g., McCarley, H. Annual cycle, population dynamics and adaptive behavior of Citellus tridecemlineatus. J. Mamm. 47, 294-316 (1966); Craven, S. R. Ground squirrels: their ecology and control [Online]. University of Wisconsin Cooperative Extension publication G3238. http://cecommerce.uwex.edu/pdfs/G3238.PDF [7 Jul. 2005]). Reliance on wild-caught specimens presents a host of unwanted variables for the researcher, not least of which are the stress of captivity and post-capture mortality.

Attempts to breed ground squirrels in captivity have been described in several publications in the 1930s and 1960s. However, these methods have the problems of low conception rates [e.g., only six copulations over several years with hundreds of animals (Johnson, G. E. & Wade, N. J. Laboratory reproduction studies on the ground squirrel, Citellus tridecemlineatus pallidus, Allen. Biol. Bull. 61, 101-114 (1931); Johnson, G. E., Foster, M. A. & Coco, R. M. The sexual cycle of the thirteen-lined ground squirrel in the laboratory. Trans. Kans. Acad. Sci. 36, 250-269 (1933))] and high rates of maternal cannibalism (Barr, R. E. & Musacchia, X. J. Breeding among captive Citellus tridecemlineatus. J. Mamm. 49, 343-344 (1968); Bridgwater, D. D. Laboratory breeding, early growth, development and behavior of Citellus tridecemlineatus (Rodentia). Southw. Nat. 11, 325-337 (1966); Zimmy, M. L. Thirteen-lined ground squirrels born in captivity. J. Mamm. 46, 521-522 (1965)).

The most recent work on captive breeding was described by Landau and Holmes in 1988 (Landau, I. T. & Holmes, W. G. Mating of captive thirteen-lined ground squirrels and the annual timing of estrus. Horm. Behav. 22, 474-487 (1988)). Ground squirrels captured from the wild were allowed to hibernate in a cold room and were then paired off (one male to two females) in specially constructed mating enclosures equipped with nest boxes. Landau and Holmes observed high conception rates and obtained viable young. However, the apparatus described was custom-built and not compatible with the standard laboratory animal equipment for a more feasible operation in a typical laboratory animal colony (i.e. “industrial”) setting.

### BRIEF SUMMARY OF THE INVENTION

The present invention provides a method for maintaining ground squirrels in captivity that can be practiced with standard laboratory animal equipments such as standard laboratory rats or mice caging equipments and food and water supply equipments. The present invention further provides a method for mating ground squirrels in captivity. Both methods involve providing at least one of a high protein diet and an artificial burrow to the ground squirrel that is being kept in captivity.

### BRIEF DESCRIPTION OF THE SEVERAL VIEWS OF THE DRAWINGS

FIG. 1 shows segments of rain gutter and metal ductwork that can be used as an artificial burrow in the present invention. The lengths of the rain gutters and metal ductwork shown range from about 15 cm to about 25 cm. The one on the left is made of plastic and has substantially square cross sections (each side of the square is approximately 7 cm) and two substantially square openings on the ends (each side of the square is approximately 7 cm). The one in the middle is made of PVC and has substantially square cross sections (each side of the square is approximately 6 cm) and two substantially square openings on the ends (each side of the square is approximately 6 cm). The one on the right is made of metal and has substantially circular cross sections (approximately 7 cm in diameter) and two substantially circular openings on the ends (approximately 7 cm in diameter).

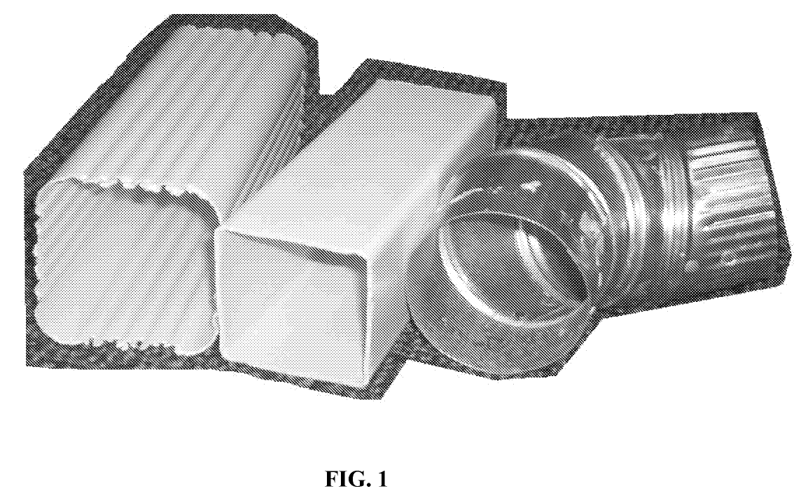

### DETAILED DESCRIPTION OF THE INVENTION

It is disclosed here that feeding a high protein diet and providing an artificial burrow are two ways of reducing stress experienced by ground squirrels while being kept in captivity. Reduced stress can lead to easier handling and transfer, improved growth, higher conception rate, reduction in maternal cannibalism in breeding colonies, and lower mortality rate during hibernation.

In one aspect, the present invention relates to a method of maintaining a ground squirrel in captivity by feeding the squirrel a high protein diet as defined below, providing the squirrel with an artificial burrow as defined below, or both. When artificial burrows are provided, it is preferred that the number of artificial burrows matches the number of animals in the cage where the squirrels are kept.

In another aspect, the present invention relates to a method of mating a male ground squirrel and a female ground squirrel by maintaining the male and female squirrels in the same cage and providing them with a high protein diet, an artificial burrow, or both. It is preferred that the number of artificial burrows matches the number of animals in the cage where the squirrels are kept. One male squirrel can be paired with more than one (e.g., up to 5 or 6) female squirrels at the same time. In one embodiment, squirrels born in captivity or have been maintained in captivity through at least one hibernation (e.g., have been maintained in captivity for over 12 months) are selected for mating. In another embodiment, squirrels that are less excitable than one or more other squirrels are selected for mating. In this regard, the temperament of a squirrel can be easily determined and compared to that of others by a skilled artisan. For example, a skilled artisan can observe the reaction of a squirrel when it is being handled and transferred. A more excitable squirrel, i.e., a squirrel with a worse temperament, would tend to bite more when being held in the hands of an observer.

The present invention can be practiced with, among others, the following Spermophilus (ground squirrel) species: S. tridecemlineatus (13-lined ground squirrel), S. beecheyi (Beechey's or California ground squirrel), S. beldingi (Belding's ground squirrel), S. franklinii (Franklin's ground squirrel), S. lateralis (golden-mantled ground squirrel), S. parryii (Arctic ground squirrel), and S. richardsonii (Richardson's ground squirrel).

By high protein diet, we mean any animal feed having a protein content of about 24% or higher by the total weight of the feed. In some embodiments, the animal feed contains at least about 25% protein, at least about 26% protein, at least about 30% protein, from about 24% to about 50% protein, from about 24% to about 45% protein, from about 26% to about 45% protein, or from about 30% to about 45% protein by weight. Preferably, the animal feed is in the form of a shaped solid and more preferably the shaped solid feed is produced by “extrusion” as typically used for preparing cat and dog food rather than by “pressing” as is typically used for preparing rat pellets. The extrusion method produces animal food that is less dense and hard in comparison to the pressing method and therefore easier for the ground squirrels to eat. A skilled artisan is familiar with animal feeds, their protein content, and methods of making them in general. For example, a commercial rat chow typically contains only about 23% protein by weight and thus is not suitable for the present invention. Other commercially available pet food and laboratory animal chows such as those for cats and dogs, on the other hand, contain at least 24% protein by weight and are thus suitable for the present invention. For example, a commercial dog chow typically contains 26% protein by weight and a commercial cat chow typically contains 30% protein by weight.

By an artificial burrow, we mean an elongated tube, straight or curved, with a side wall that defines an elongated inner compartment or channel and two openings at two ends of the tube (end openings). Alternatively, at least one of the end openings is closed by an end wall. If both end openings are closed, at least one opening is provided on the side wall. The purpose of the artificial burrow is to provide a hiding place for the squirrel (e.g., a weaned or older squirrel) that is being kept in captivity. The artificial burrow may be constructed of any material (e.g., cardboard, plastic, metal, or wood). Preferred materials are those that resist chewing (e.g., metal or PVC plastic). The inner compartment and the openings are dimensioned to accommodate the squirrel's body circumference and entire length and permit ingress and egress of the squirrel but are sufficiently small to provide a natural burrow feeling. In this regard, the lengths of the tube and the length of the inner compartment is longer (e.g., at least 1.1 times, 1.2 times, 1.3 times. 1.4 times, 1.5 times, or 2.0 times longer) than both the largest dimension of the openings and the largest dimension of any cross section of the inner compartment made along and substantially perpendicular to the axis that defines the length. Further, any said cross section or opening is sufficiently large in all dimensions to accommodate the squirrel's body circumference but the largest dimension of said cross section and the largest dimension of the opening are at most twice, preferably at most 1.5 times, more preferably at most 1.3 times, and even more preferably at most 1.2 or 1.1 times of the largest dimension of any cross section of the squirrel made along and substantially perpendicular to the length of the squirrel. In one embodiment, the smallest dimension of the cross sections and the openings is at least about 3, 4, 5, or 6 centimeters and the largest dimension of the cross section and the opening is about 7, 10, or 15 centimeters or smaller; the length of the inner compartment is at least about 10 centimeters or at least about 15 centimeters and preferably from about 10 centimeters to about 300 centimeters, from about 10 centimeters to about 200 centimeters, from about 10 centimeters to about 100 centimeters, from about 10 centimeters to about 50 centimeters, or from about 15 centimeters to about 25 centimeters. In the case of a relatively large cage such as one used for group caging, the length of the inner compartment may be the longest dimension of the cage minus approximately 10, 15, or 20 centimeters. The exact shape of the cross sections of the compartment and openings is not critical to the present invention as long as it can accommodate the squirrel's body circumference. In one embodiment, the elongated tube is substantially cylindrical or cuboid in shape and the inner compartment has substantially circular, square, or rectangular cross sections and openings. In one form, the substantially circular cross section has a diameter of about 5 centimeters to about 10 centimeters and the substantially square or rectangular cross sections has sides of about 4 centimeters to about 10 centimeters. The length of the compartment of the cylindrical or cuboid tube, in one form, may range from about 10 or 15 centimeters to about 25 or 100 centimeters. In one example, the openings and the cross sections of the elongated tube are minimally sized to admit a squirrel's body circumference and entire length. In another example, a rain gutter or ductwork of a suitable size is employed as an artificial burrow.

For the purpose of the present invention, a squirrel may be maintained in a cage and an artificial burrow is provided inside the cage. For example, a standard laboratory rat or mouse cage can be used and a high protein animal feed in the form of a shaped solid can be provided through the wire top of the cage. A water bottle can also be provided through the wire top. Optionally, the high protein diet is supplemented with seeds, vegetables, or both. Examples of seeds that can be used include but are not limited to sunflower seeds, safflower seeds, or peanuts. Examples of vegetables that can be used include but are not limited to carrots, celery, turnip greens, or sweet corn. Also optionally, contact bedding can be provided. Examples of materials that can be used for contact bedding include but are not limited to wood shavings, paper products, or corn cobs. In addition, materials that squirrels can shred to make hibernation nests or nests for the young can be provided when appropriate. Examples of such materials include but are not limited to paper towels (e.g., brown paper towels), paper products designed for animal nesting (e.g., Nestlets® made by Ancare), cardboard, cloth or fabric, and newspaper. In a preferred example, the squirrels are maintained in clear plastic cages with contact bedding such as that made of aspen shavings.

The invention will be more fully understood upon consideration of the following non-limiting example.

### EXAMPLE

### Capture, Care, and Captive Breeding of 13-Lined Ground Squirrels, Spermophilus tridecemlineatus

The 13-lined ground squirrel has been used for studies of hibernation biochemistry and physiology, as well as for modeling a variety of diseases and potential biomedical applications of hibernation physiology. This example describes a method for maintaining 13-lined squirrels in captivity and captive mating of the squirrels.

Capture, Parasite Load, and Mortality

Prior to capture, we obtained a Scientific Collector's permit from our state Department of Natural Resources and approval from the Institutional Animal Care and Use Committee; also, all personnel attained animal care certification. Thirteen-liners are distributed over most of central North America, where they prefer short-grass habitats. Ours were captured, with permission, from several cemeteries in the vicinity of Oshkosh, Wisconsin (latitude 44°, altitude 229 m) in the summers of 2002, 2004, and 2005. Capture was predicated on observable surface activity, which in Wisconsin is reportedly maximized when ambient temperature is between 30° C. (86° F.) and 40° C. (104° F.) (Vispo, C. R. & Bakken, G. S. The influence of thermal conditions on the surface activity of thirteen-lined ground squirrels. Ecology 74, 377-389 (1993)) and when it is sunny (Craven, S. R. Ground squirrels: their ecology and control [Online]. University of Wisconsin Cooperative Extension publication G3238. http://cecommerce.uwex.edu/pdfs/G3238.PDF [7 Jul. 2005]).

Capture equipment included nets, heavy leather gloves, empty plastic bin cages with wire tops (no bedding), medium-sized plastic garbage cans (for toting tap water), and a dolly or cart (for carrying the cans of water). Type of net is important, as it is a most important tool with this species. We have obtained years of satisfactory service in the field and in the animal facility from a 12-inch diameter, soft fabric entomology net with a 32-inch wooden handle (Entoproducts, Kewauskum, Wis.).

Spotters were placed in the cemetery habitat. When a 13-liner was observed, the spotter slowly walked towards it until it disappeared down a burrow. The net was placed over the burrow entrance and tap water was poured steadily into the burrow until the animal exited, running directly into the net. Occasionally, the burrow capacity exceeded the volume of water applied and no animal was forthcoming. Rarely, the animal exited a different burrow a short distance away.

Capture excursions during mid-to-late May yielded mostly pregnant females along with a few adult males, whereas excursions in June yielded only lactating females who were immediately released. Excursions in mid-July and thereafter yielded weanling young of the year, with an occasional adult female. Weanlings are reported to be less vigilant than adults due to their greater nutritional needs (Arenz, C. L. & Leger, D. W. Antipredator vigilance of juvenile and adult thirteen-lined ground squirrels and the role of nutritional need. Anim. Behav. 59, 535-541, 2000) and were thus probably spotted more often.

This capture pattern may be explained by hibernation immergence patterns in the wild, whereby the first animals to enter torpor are adult males, followed by adult females who did not wean a litter, then adult females who did wean a litter, and finally by weanlings (Craven, S. R. Ground squirrels: their ecology and control [Online]. University of Wisconsin Cooperative Extension publication G3238. http://cecommerce.uwex.edu/pdfs/G3238.PDF [7 Jul. 2005]). This immergence schedule is explained by relative reproductive and growth costs that must be met before sufficient fat is stored to support hibernation. We never trapped beyond the end of August due to lack of time, but a commercial trapper (TLS Research, Bartlett, Ill.) provides animals in August and September. Newly-caught wild animals were always housed in a quarantine room for at least one week before moving into the main colony.

Upon arrival in the facility, a subset of wild-caught and captive-reared animals was examined for parasites. Thirteen captive-born and five wild-caught squirrels were randomly selected and examined for ecto- and endoparasites. Ectoparasite survey was performed by combing and close observation. Peripheral blood was obtained by toenail clip, and Giemsa-stained smears were made for detection of hemoparasites. Fecal samples were qualitatively examined by microscopic examination of direct preparations in phosphate buffered saline (PBS, pH 7.2) and by trichrome staining (ENG Scientific, Clifton, N.J.). When coccidia were detected in direct preparations, feces were incubated in 2.5% K₂Cr₂0₇ to induce sporulation and were reexamined by light microscopy for genus determination. Intestines of freshly-euthanized wild-caught animals were examined by dissection, then by mucosal scrapes after incubation at room temperature in PBS overnight.

Fleas and ticks were not observed in the wild-caught (or captive) animals examined, though ground squirrels can act as hosts for many different ectoparasites (Patrick, M. J & Wilson, W. D. Parasites of the Abert's squirrel (Sciurus aberti) and red squirrel (Tamiasciurus hudsonicus) of New Mexico. J. Parasitol. 81, 321-324 (1995)). Of the wild-caught squirrels examined upon capture, one presented with intestinal amebas (Entaboeba spp.) (Jahn, T. L., Bovee, E. C. & Jahn, F. F. How To Know the Protozoa 2nd edn. (Wm. C. Brown Company Publishers, Dubuque, Iowa. 1979)) and trichomonad (Order Trichomonadida) and retortamonad (Chilomastix mesnili) flagellates; one with an adult tapeworm (Family Hymenolepididae) and coccidia (Eimeria spp., Patrick, M. J & Wilson, W. D. Parasites of the Abert's squirrel (Sciurus aberti) and red squirrel (Tamiasciurus hudsonicus) of New Mexico. J. Parasitol. 81, 321-324 (1995)); one with C. mesnilii and an unidentified larval nematode; one solely with trichomonads; and the last apparently devoid of intestinal parasites.

Infection by tapeworms in the wild-caught squirrel was most likely the result of ingestion of fleas during grooming or by predation of other arthropod hosts. No nematode, trematode or cestode ova were observed in the feces of laboratory-raised ground squirrels (i.e. the offspring of wild-caught parents never treated for parasites), suggesting that regular bedding changes curtail transmission of many intestinal parasites from mother to young. Oocysts of Eimeria spp. were observed in the feces of one laboratory-raised squirrel.

The use of good management practices minimizes parasite transmission between animals housed in group caging situations. If desired, a single treatment for most internal and external parasites is oral ivermectin such as Ivomec™ 1% Injection (Merial Ltd., Duluth, Ga.). This is mixed as 1 part to 199 parts vegetable oil, to a final concentration of 0.05 mg/ml. The final oral dose of 0.02 mg per kg body mass can be given using a needle-less 1 cc plastic syringe or micropipettor. For example, a 100 g ground squirrel would be given 0.04 ml (40 μL) of the 0.05 mg/ml ivermectin-oil mixture.

Additionally, metronidazole for intestinal flagellates and amebas (Flagyl®, Searle; 20 mg/kg SID or PO) can be used, as well as praziquantel for cestodes (Droncit®, Bayer; 25 mg/kg PO or SQ, repeat in 10 days), and coccidiostats such as amprolium for prevention of coccidia transmission (Corid®, Merial, 0.012-0.025% in drinking water). Preparations suitable for cats must be used since ground squirrels also lick themselves to stay clean. It should be noted that these measures, in combination with the low exercise levels produced from caging, may result in higher body weights for laboratory-reared animals than for wild type.

From 2002 to 2005, we have had approximately 11% mortality in newly caught wild animals (Table I). Shortly after capture, one exhibited bleeding from the mouth and was euthanized; a postmortem dissection revealed only gastric bleeding, suggesting the animal had ingested rodenticide prior to its capture and would have died anyway. One sustained a leg injury (apparently self-inflicted as it was housed alone) and was euthanized. One failed to thrive and died before it entered hibernation. Two manifested symptoms of a vestibular disorder (running in tight circles with the head held to the side) and were euthanized. Since the two affected animals were each the sole case of the disorder in two different capture years, this disorder must not be very contagious.

In only two circumstances have we experienced mortality during hibernation. Two wild animals captured as weanlings, fed the rodent chow diet (as recommended in the literature), and housed alone during hibernation, died during hibernation. Three captive-born weanling animals housed before and during hibernation with same-sex littermates sustained injuries from the littermate during hibernation. We do not know if these were the cause of death or occurred after death. Since adopting a higher protein diet (see below) and housing hibernating animals strictly alone, we have not lost any animals during hibernation.

TABLE I
Record of 2003-2005 captive breeding efforts. Breeding success
reflects pairs producing an observed litter (cannibalized litters may
have been missed). Only 6 animals were overwintered during 2004-5,
so there were only 4 breeding pairs in 2005, yet 3 of the 4 pairs produced
pups, all of which were weaned. 2005 was the first year that breeding
pairs were fed a cat food based diet. All successful captive-breeding
parents thus far have been captured in the wild as young of the year and
overwintered once or twice in captivity prior to reproducing.

| | | | | No. | | |
|---|---|---|---|---|---|---|
| Calen- | No. | Post- | | litters/ | | |
| dar | wild | capture | Breeding | pups | % | % |
| Year | caught | mortality | Pairs | born | fecundity | weaned |
| 2002 | 27 | 4 | 0 | n/a | n/a | n/a |
| 2003 | 0 | n/a | 9 | 1/7 | 11% | 100% |
| 2004 | 12 | 1 | 9 | 3/19 | 33% | 0% |
| 2005 | 14 | 1 | 4 | 3/21 | 75% | 100% |
| 2006 | 0 | n/a | 16 | 12/97 | 75% | 100% |

Caging and Hygiene

S. tridecemlineatus is considered an asocial species (Rayor, L. S. & Armitage, K. B. Social behavior and space-use of young of ground-dwelling squirrel species with different levels of sociality. Ethol. Ecol. Evol. 3, 185-206 (1991)). Females defend a home burrow through intrasexual aggression that increases with population density (Luna, L. D. & Baird, T. A. Influence of density on the spatial behavior of female thirteen-lined ground squirrels, Spermophilus tridecemlineatus. Southw. Nat. 49, 350-358 (2004)) but is nonetheless not considered a high degree of aggression among sciurids (McLean, I. G. in The Biology of Ground-dwelling Squirrels: Annual Cycles, Behavioral Ecology, and Sociality (eds. Murie, J. O. & Michener, G. R.) 321-335 (University of Nebraska Press, Lincoln, Nebr., 1984); Wistand, H. Individual, social, and seasonal behavior of the thirteen-lined ground squirrel, Spermophilus tridecemlineatus. J. Mamm. 55, 329-347 (1974)).

Except during the breeding season (April through June or July), we maintained adult 13-liners individually in standard, clear plastic rat bins, 43×21×20 cm, with wire tops. We have also found it possible to house weaned littermates in pairs in the same size cages during the summer and fall. We used wood shavings as bedding and provided an approximate 8 inch length of plastic rain gutter tubing (per animal) as a burrow. The rain gutter is easily sanitized and has proven invaluable for transporting animals between cages; they readily enter it with little encouragement and have never offered to bite when bare hands are placed over each end for carrying. Chewing of the rain gutter burrows has not been a problem.

Water was offered to all ages by a standard bottle with metal sipper tube. Chow was offered to adults in a depression built into the wire cage top or, to juveniles, in a shallow hard plastic dish. Supplementary foods (greens and seeds) were offered in the bedding to simulate natural foraging.

Thirteen-liners generally eliminated in one corner of the cage, so spot cleaning was feasible when changing to a completely clean cage was impractical. More frequent cleaning was needed when two or more animals were caged together or whenever a water bottle discharged its contents. As a precaution against stress, cage cleaning was suspended for the first week that a female had a litter; spot cleaning was done during the second week; and regular cleaning resumed by the third week, during which the entire nest of infants was lifted intact and transferred to the clean bin.

Diet

Commercial rat chow is frequently cited as the base diet for 13-liners. However, we found that 13-liners do not readily eat rat chow well and we believe that a typical rat chow does not contain enough protein either. We fed our 13-liners a base diet of commercial dog chow (IAMS Chuncks) or cat chow (Purina Indoor Formula), containing 26% or 30% protein, respectively. This compares to only 23% protein in commercial rat chow. Significantly, we observed improved growth and ceased to observe both maternal cannibalism in the breeding colony and death during hibernation once we switched to higher protein dog or cat chow. The chow diet was supplemented with sunflower seeds and greens (carrots and celery).

Thirteen-liners cache food for a day or two during summer arousal, both in the artificial laboratory situation (Livoreil, B. & Baudoin, C. Differences in food hoarding behavior in two species of ground squirrels Spermophilus tridecemlineatus and S. spilosoma. Ethol. Ecol. Evol. 8, 199-205 (1996)) and in the wild (Devenport, J. A., Luna, L. D. & Devenport, L. D. Placement, retrieval, and memory of caches by thirteen-lined ground squirrels. Ethology 106, 171-183 (2000)), but do not cache food for consumption during hibernation (Craven, S. R. Ground squirrels: their ecology and control [Online]. University of Wisconsin Cooperative Extension publication G3238. http://cecommerce.uwex.edu/pdfs/G3238.PDF [7 Jul. 2005]). Therefore, during the months of hibernation, we withheld water and food.

Photoperiod

Aroused squirrels were maintained in rooms equipped with standard overhead fluorescent lighting controlled by a programmable timer. Photoperiod was adjusted every two weeks to match the actual sunrise and sunset in the county of capture. The hibernaculum was kept dark except for brief periods of routine animal inspection.

Restraint

Torpid animals curled in the characteristic fetal position could be picked up without gloves. Cold to the touch, their extremities were bright pink showing normal oxygenation.

Aroused animals are more difficult to handle. “Scruffing” this agile animal is not easy to do, meaning that picking them up involves grasping them around their bodies. Once they are weaned, they usually respond to this by biting hard, necessitating that handlers wear heavy leather gloves. Thirteen-liners are capable of tail autotomy, so care must always be taken not to accidentally grasp an animal by its tail. By far the easiest way to pick up a 13-liner is in its plastic raingutter burrow.

Fall and Winter Care

Joy (Joy, J. E. in The Biology of Ground-dwelling Squirrels: Annual Cycles, Behavioral Ecology, and Sociality (eds. Murie, J. O. & Michener, G. R.) 125-141 (University of Nebraska Press, Lincoln, Nebr., 1984)) has reported that wild-caught 13-liners from two different latitudes (Texas versus Michigan) retain the circannual cycle of their capture site (i.e., the southern animals enter hibernation later, and emerge earlier, than their northern conspecifics). In captivity, by mid-October and sometimes as early as mid-August, most of our 13-liners had already begun to cycle in and out of torpor, with body temperatures dropping to match ambient (about 70° F.). It was not unusual to observe a 13-liner staggering about as if ill, only to find that it was cool to the touch and thus either entering or exiting a bout of torpor. Probably because of the ad lib food supply during the preceding months of arousal, we saw little difference in the immergence timing of the various sexes and ages amongst captive 13-liners.

In mid-September, brown paper towels were added to the bedding, which the animals shredded to make large hibernation nests. During cage cleaning, these nests were not discarded, but were transferred en masse to the clean cage. We also noted a marked reduction in consumption of food and production of feces and urine, evidence that significant periods of torpor had begun.

Animals passing through observed torpor at least twice were moved into in a 38±3° F. hibernaculum and, by late October, all animals were moved there. Even aroused 13-liners that had not previously exhibited torpor promptly immerged into hibernation. The hibernaculum was kept dark except during brief daily periods of inspection. Any newly-installed 13-liner that emerged from hibernation, and remained aroused for more than 48 hours, was returned to the warm room and reinstated with food and water for another week or two before another attempt at immergence, but this rarely occurred. Most animals remained in hibernation until early April, but in 2003, one male emerged in late January and remained aroused till the following October.

Spring Care and Breeding

A variety of practices have been published with respect to the timing of vernal emergence in captive populations. In some cases, a date is chosen and all animals are removed from the hibernaculum into the warm, lit room. Ad lib feeding and watering is always immediately reinstated for any animal removed from the hibernaculum. In other cases, whenever an animal exhibits arousal lasting more than 48 hours, all males are removed from the hibemaculum and returned to individual cages at normal room temperature. We have elected the latter method for captive breeding purposes. Males spend two weeks in the warm, lit environment prior to the introduction of any females, during which time their regressed testicles regenerate, enlarge, and acquire the black pigmentation indicative of breeding readiness.

Despite little sign of spring arousal, females were removed to the warm, lit environment two weeks after the males were moved there, and feeding and watering were reinstated. Forty-eight hours later, mixed genders were placed in each mating enclosure.

The natural mating system of 13-liners has been termed “scramble competition polygyny” (Schwagmeyer, P. L. & Wootner S J. Scramble competition polygyny in thirteen-lined ground squirrels: the relative contributions of overt conflict and competitive mate searching. Behav. Ecol. Sociobiol. 19, 359-364 (1986)). Multiple males may copulate with each female in the wild (Schwagmeyer, P. L. in The Biology of Ground-dwelling Squirrels: Annual Cycles, Behavioral Ecology, and Sociality (eds. Murie, J. O. & Michener, G. R.) 275-294 (University of Nebraska Press, Lincoln, Nebr., 1984)), but sperm competition produces a first-male advantage (Schwagmeyer, P. L. & Foltz, D. W. Factors affecting the outcome of sperm competition in thirteen-lined ground squirrels. Anim. Behav. 39, 156-162 (1990)). Male 13-liners are reported to engage in conflicts when competing for estrous females in the spring, although they are not the most aggressive ground squirrel species in this regard (Yahyaoui, I. E., Gouat, P. & Livoreil, B. Male-male encounters in Spermophilus tridecemlineatus: comparison with other Spermophilus ictidomys species. Comptes. Rendu. 318, 229-235 (1995)) and the conflicts seem to be limited to chasing (Schwagmeyer, P. L. in The Biology of Ground-dwelling Squirrels: Annual Cycles, Behavioral Ecology, and Sociality (eds. Murie, J. O. & Michener, G. R.) 275-294 (University of Nebraska Press, Lincoln, Nebr., 1984)). There is little evidence for territoriality in wild female 13-liners (McLean, I. G. in The Biology of Ground-dwelling Squirrels: Annual Cycles, Behavioral Ecology, and Sociality (eds. Murie, J. O. & Michener, G. R.) 321-335 (University of Nebraska Press, Lincoln, Nebr., 1984); Wistand, H. Individual, social, and seasonal behavior of the thirteen-lined ground squirrel, Spermophilus tridecemlineatus. J. Mamm. 55, 329-347 (1974)).

In our hands, one male was able to impregnate up to three females with even higher ratios possible. Wild males are reported to abandon females after a copulation time threshold of 9 minutes has been reached (Schwagmeyer, P. L. & Parker, G. A. Mate-quitting rules for male thirteen-lined ground squirrels. Behav. Ecol. 5, 142-150 (1994)) and females may become unreceptive as little as 3 hours after copulation (Schwagmeyer, P. L. in The Biology of Ground-dwelling Squirrels: Annual Cycles, Behavioral Ecology, and Sociality (eds. Murie, J. O. & Michener, G. R.) 275-294 (University of Nebraska Press, Lincoln, Nebr., 1984)). Copulation has been reported to occur above ground in the wild (Schwagmeyer, P. L. in The Biology of Ground-dwelling Squirrels: Annual Cycles, Behavioral Ecology, and Sociality (eds. Murie, J. O. & Michener, G. R.) 275-294 (University of Nebraska Press, Lincoln, Nebr., 1984)).

For mating enclosures, we purchased large plastic children's sandboxes with internal dimensions of about 90×65×35 cm from a local discount department store. We selected these due to ease of handling, storage, and sanitization. Holes were cut in the plastic lid and sealed with wire mesh, through which the water bottles were suspended. Bedding was wood shavings and paper towels. Bedding was changed twice per week and any nest that was built was not discarded but was carefully moved to the clean bedding.

We found that it is not necessary to provide any hiding place for the litters in the mating enclosure as litters were always located out in the open, in cup-shaped nests fashioned from shredded paper towels. It is necessary only to provide the adults with a hiding place, i.e., the same plastic rain gutters described above for standard caging.

In a previous publication describing captive breeding of 13-liners (Landau, I. T. & Holmes, W. G. Mating of captive thirteen-lined ground squirrels and the annual timing of estrus. Horm. Behav. 22, 474-487 (1988)), it was shown that a 22 day delay (after spring emergence) in placing males with females prevents conception, apparently by suppression of behavioral estrus. We have obtained healthy first litters from captive females who (based on a consensus gestation period of 28 days) were impregnated within a week of first exposure to a male, as is proposed to occur in the wild, or who were impregnated as much as 30 days later. In this case of delayed impregnation, exposure to the male had been continuous. To maximize conception, it is preferable that males and females remain together in the mating enclosures all summer, until a female produces a litter or until the male's testicles have regressed out of breeding condition.

In this extended male-female exposure scenario in the mating enclosures, we routinely observed adult animals laying together in a relaxed fashion, or sharing a burrow when disturbed by routine animal care. There was no evidence of fighting or injury despite group caging. When litters remained until weaning in the mating enclosure, there was no infant cannibalism by the sire, by the dam, or by any additional female in the enclosure for mating to the same sire.

In males whose entire “harem” had borne a litter earlier that spring, we observed regression of the testicles prior to July 1. In males whose “harem” included at least one nulliparous female, we observed retention of fully developed, pigmented testes past this date.

All successful breeders (male and female; Table I) were either animals caught the prior year as young of the year, or were animals born in captivity (to captive or wild dams) the prior year. In both instances, the successful breeders had grown to adulthood in captivity and were thus accustomed to it. In our facility, litter size has ranged from six to twelve, in accordance with published values from the wild.

Care of the Young

Only the female 13-liners are known to care for the young (Schwagnieyer, P. L. in The Biology of Ground-dwelling Squirrels: Annual Cycles, Behavioral Ecology, and Sociality (eds. Murie, J. O. & Michener, G. R.) 275-294 (University of Nebraska Press, Lincoln, Nebr., 1984)). In wild populations living at high latitude and elevation, males enter hibernation so early in the summer that they may miss any opportunity to care for (or interfere with) the young. We have kept sires in the same breeding cage with lactating dams and their young, and have observed no problems.

In one instance, two females in the same mating enclosure bore their litters within the same 24 hour period and combined the two litters into one group of 14 neonates in the same nest. All were successfully reared.

Enlargement of the teats, rather than engorged mammae, were the identifiers of nursing dams. Nursing dams consumed nearly a bottle of drinking water each day during peak lactation. Animal caretakers should monitor the availability of water during this time. Providing moist foods in the form of greens was also a benefit.

Neonates are very mobile. We commonly observed a week-old “pinkie” crawling several inches from the nest. Apparently, an adult returned each wandering infant to the nest, as we experienced no infant mortality in 2005.

From the age of about 14 days onward, cat chow is preferably offered in a shallow dish so that juvenile 13-liners could reach it. This eases their transition to the adult diet which is completed at the age of about 30 days. We continued this easy access feeding practice for at least four weeks following weaning, or until the animals were of sufficient size to reach the overhead food compartment in the wire cage top.

We observed eye opening at 20-25 days after birth. Even prior to eye opening, juvenile 13-liners are extremely vocal, sounding the characteristic whistling alarm call far more often than the adults did. Weanlings are far more skittish than adults unless they are handled daily from the age of 14 days or so onward, but this is a temporary phase. Females are more skittish than males, at all ages.

Handling of pups from an early age to reduce skittish behaviors must be weighed against stressing the dam and possibly triggering cannibalism. Based on our experience, maternal cannibalism occurs within the first four days after birth, it is preferable to wait until the pups are a week old to commence handling, during which time the dam should be encouraged to hide in her rain gutter burrow and perhaps offered sunflower seeds as a reward. Initial handling consists of merely lifting the pups to cup them in the hand. After eye opening, handled pups readily explore a person seated on the floor. Pups that are handled daily exhibit far less alarm behavior upon weaning and thereafter, and are easier to handle than pups that are never handled. As adults, handled pups can be lifted with a flat open palm and gently transferred into a new cage without incident, but will still bite if gripped tightly. A few learned to climb out of one cage into another with a little encouragement.

At the age of 30 days, roughly a week after eye-opening, the pups moved easily about the cage and were observed eating chow, greens, and seeds. They were then separated from their dams and placed into standard bin caging supplied with cat chow and greens in a shallow dish. They were easily sexed at this age by simple inspection: the male anogenital distance is approximately twice that of the female.

During the 2005 breeding season, we also captured pregnant females from the wild who subsequently gave birth in captivity. These wild-caught females were individually housed in standard bin-style lab caging instead of the mating enclosures. They readily accepted the cat and dog chow, plastic rain gutter burrow, and water bottle. All pregnant wild females constructed the same sort of shredded paper towel nest as did the captive-born breeders and successfully bore and cared for their pups. There was no mortality or cannibalism.

Producing Two or More Litters by Manipulating the Timing of Spring Emergence (Prophetic)

To maximize production of the breeding colony, we will manipulate the annual hibernation schedule of breeding stock to achieve off-calendar mating and multiple births per breeding pair per year. Normally, wild ground squirrels hibernate approximately from October through April (i.e., approximately 20-30 weeks depending on weather), mate shortly after emergence, deliver the young a month later, and then re-enter hibernation the following fall with no further matings or births that “wild” calendar year. In captivity, we will provide abundant food to animals of both sexes post-reproduction to enable their hibernation as soon as possible, for example in August instead of October. We will apply proper stimuli (food deprivation and short daylength consistent with winter) to induce the onset of hibernation and place them into the dark cold room (hibernaculum, e.g., approximately 35-40° F.) as described above. Rather than be tied to the normal “wild” calendar year with 20-30 weeks of hibernation, we will remove animals from hibernation after only 4-16 weeks of hibernation. Males must be removed first to permit regeneration of their reproductive organs to functionality; females are removed about 2 weeks later and should come immediately into estrus. Animals brought early out of hibernation will be placed in a warm room (e.g., approximately 65-75° F.) with long daylength (consistent with summer) and plenty of food, to permit reproduction. Mating procedures will be the same as described above. In this way, we will produce litters at times independent of the natural “wild” calendar and, with the accelerated hibernation schedule (only 4-16 weeks of hibernation rather than the normal 20-30 weeks), we will produce more than one litter per breeding pair per year.

To maximize productivity of the colony, we will select future breeding stock not only for temperament that thrives in captivity, but also for demonstrated reproductive plasticity that permits accelerated-calendar mating and multiple matings per year.

Occasionally one observes a ground squirrel that seems unresponsive to the stimuli for hibernation (e.g., body weight gain, shorter daylength, food deprivation, lower room temperature). Such individuals may be termed “non-hibernators”. When we identify individual non-hibernators, we will combine them as breeding pairs. Their offspring will be monitored over suybsequent generations, the breeders for which in turn will be selected for non-hibernation. In this fashion, we expect to obtain a strain of ground squirrels that does not hibernate, as has previously been reported for laboratory-bred hamsters (Chaffee, R. R. On experimental selection for super-hibernating and non-hibernating lines of Syrian hamsters. J. Theor Biol. 12, 151-4 (1966); Lyman, R C. P, O'Brien R. C., and Bossert W. H. Differences in tendency to hibernate among groups of Turkish hamsters (Mesocricetus brandti). J. Therm. Biol. 8, 255-257 (1983)).

The present invention is not intended to be limited to the foregoing example, but encompasses all such modifications and variations as come within the scope of the appended claims.

We claim:

1. A method for maintaining a ground squirrel in captivity comprising the step of:
feeding the squirrel with an animal feed that comprises at least about 24% protein by weight.

2. The method of claim 1, wherein the ground squirrel is selected from Spermophilus beecheyi, Spermophilus beldingi, Spermophilus franklinii, Spermophilus lateralis, Spermophilus parryii, Spermophilus richardsonii, or Spermophilus tridecemlineatus.

3. The method of claim 1, wherein the feed comprises at least about 26% protein by weight.

4. The method of claim 1, wherein the feed contains at least about 30% protein by weight.

5. The method of claim 1, wherein the feed contains from about 30% protein to about 45% protein by weight.

6. The method of claim 1, wherein the feed is in the form of a shaped solid.

7. The method of claim 6, wherein the solid feed is produced by extrusion.

8. The method of claim 1, wherein the animal feed is selected from a cat food or a dog food.

9. The method of claim 1, further comprising the step of keeping the ground squirrel in a cage with contact bedding.

10. The method of claim 9, wherein the contact bedding comprises wood shavings.

11. The method of claim 10, wherein the contact bedding further comprises a paper towel.

12. The method of claim 9, wherein the cage is a transparent plastic cage.

13. The method of claim 1, further comprising the step of feeding the ground squirrel a supplemental food selected from a seed or a vegetable.

14. The method of claim 1, further comprising the step of providing an artificial burrow to the squirrel.

15. A method for maintaining a ground squirrel in captivity comprising of the step of:
providing an artificial burrow to the ground squirrel.

16. A method for mating a male ground squirrel and a female ground squirrel comprising the steps of:
maintaining the male and the female squirrels in the same cage; and
feeding the male and female squirrels with an animal feed that comprises at least 24% protein.

17. The method of claim 16, further comprising the step of providing inside the cage an artificial burrow.

18. The method of claim 17, wherein the number of artificial burrow matches the number of animals in the cage.

19. The method of claim 16, wherein the male and female squirrels are born in captivity or have hibernated in captivity at least once.

20. The method of claim 16, further comprising the step of determining how excitable the male and the female squirrels are relative to one or more other squirrels.
